(19) United States
(12) Patent Application Publication
(10) Pub. No.: US 2017/0128950 A1
(43) Pub. Date: May 11, 2017

(54) Low Power Biomass Shredder and Composting System Enabled for Continuous Feed of Material for Composting

(71) Applicant: Innovaat.com International Inc., St. Adolphe (CA)

(72) Inventor: Raymond Dueck, St. Adolphe (CA)

(21) Appl. No.: 14/934,300

(22) Filed: Nov. 6, 2015

(51) Int. Cl. B02C 18/14; B02C 23/16; B02C 18/20

(52) U.S. Cl. CPC B02C 18/142; B02C 18/20; B02C 23/16; B02C 2018/162

(57) ABSTRACT

A low speed low power shredder for biomass material a single drum or two spaced rotary drums supported in a housing having a cylindrical wall with a plurality of outward shear members spaced longitudinally and radially of the cylindrical wall so as to pass a cooperating element in a shearing action. The shear members form ends of a support plate extending diametrically through the wall so as to provide structural support. In the two drum system, a top grate member is mounted in the feed throat and a bottom grate member is provided underneath the plane of closest approach. Each of these grate members provide shearing actions with the shear members. Additionally, a composting machine is arranged to be fed by a shredder, and thus includes an input conveyor supported at a position coaxial with a rotary vessel of the composter and a tubular support member which defines one location at which the rotary vessel is supported in its rotation about its axis.

This invention relates to a shredder for biomass material which includes at least one rotary drum supported in a housing with a cylindrical wall and a plurality of outward shear members spaced longitudinally and radially of the cylindrical wall so as to pass between bars in a shearing action.

The arrangement of the present invention is particularly but not exclusively useful to provide a shredder of low speed and low power. The shredder may include a single drum or a pair of cooperating drums where part or all of the shearing action occurs between the shear members and stationary bars supported by the housing.

A shredder like that disclosed in this specification may also be suited for directly feeding a composting machine. In order to facilitate continuous feeding of the composting machine while the composter is operating, the composting machine which comprises a rotary vessel thus includes an input conveyor supported at a position coaxial with the rotary vessel and a tubular support member which defines one location at which the rotary vessel is supported in its rotation about its axis. The input conveyor is held at a suspended position within the tubular support member such that the tubular support member is rotatable about the input conveyor.

### BACKGROUND OF THE INVENTION

Rotary shredders are known in many designs commonly used for shredding paper which requires little power. The present arrangement is proposed for use with biomass material such as tree cuttings, waste wood materials and similar combustible products which can be shredded to provide feed for a furnace or can be compostable so as to be used in a composting process. Such shredders are typically high speed with a high power requirement so that the assembly is necessarily of high cost taking it out of reasonable financial reach of individual farmers, home owners and small businesses who want to have a dedicated shredder at their property to provide fuel.

Furthermore, shredded biomass material is suited for composting. Shredders may be arranged in order to directly feed a composting machine. However, typical constructions of composters may not be suited for being continuously and directly fed by a composter in a manner which allows uninterrupted operation of the composter.

### SUMMARY OF THE INVENTION

It is one object of the present invention to provide a shredder for biomass material which can be operated at low power to enable use in an economical construction.

According to one aspect of the invention there is provided a shredder for biomass material comprising:

at least one generally cylindrical rotary member mounted for rotation about a longitudinal axis;

a housing within which said at least one rotary member is mounted and defining a feed opening for receiving the biomass material;

said at least one rotary member having a cylindrical wall defining a hollow interior with a plurality of shear members projecting generally radially outwardly of the cylindrical wall;

each shear member having a leading surface, a trailing surface and first and second side surfaces;

the shear members being arranged in an array where the shear members of the array are spaced longitudinally and radially of the cylindrical wall;

the shear members being arranged in the array thereof such that at least some of the shear members of the first rotary member pass respective cooperating components in a shearing action between one of the side surfaces of said at least one of the shear members and a surface of said respective cooperating component;

wherein the shear members are arranged in pairs with each pair including an elongate structural member extending through the hollow interior of the rotary member on each end of which respective one of the pair is mounted.

Preferably the elongate structural members extend diametrically or transversely through the rotary member. The arrangement of elongate structural members defining the shear members on the ends provides a weight reduction of the drum thus reducing the mass required for the outer cylindrical wall.

Preferably each of the shear members has a leading surface which is concave in a direction longitudinally of the leading surface so as to form a hook portion which tends to grasp and pull the biomass material though the throat.

Preferably the pair of shear members and the elongate structural member thereof are formed from an integral plate with the leading surface of each shear member being forming at one edge of the plate. The plate can then be relatively narrow in width and thus relatively light in weight and is held in its position within and through the rotary drum by the wall of the drum and thus forming a simple light weight construction.

Preferably the cylindrical wall is imperforate, that is it is a solid continuous wall forming a cylindrical drum. However other types of outer wall can be provided which have holes or have a structure other than a drum.

Preferably the cylindrical wall is open at the ends for light weight construction as the ends do not cooperate with the biomass material.

Preferably each shear member is spaced both longitudinally and angularly of its next adjacent shear member. That is the shear members are not side by side but staggered to avoid high pulses of power which occur if shear members shear at the same time.

In one arrangement, the at least one rotary member comprises first and second rotary members mounted for rotation about parallel axes in opposed directions, the first and second members being supported so as to define, at a plane of closest approach containing the axes of the rotary members, a space therebetween and forming a throat on a feed side of the plane. The housing defines the feed opening which is arranged such that the biomass material fed into the feed opening enters the throat to pass through the space. The shear members are preferably arranged in the array such that the shear members of the first rotary member do not cooperate in a shearing action with the shear members of the second rotary member, that is they are angularly offset.

Preferably there is provided a top grate member in the throat including a support member in the form of a beam extending along the throat generally parallel to the axes. A plurality of first bars extend at right angles to the support member at spaced positions along the support member for cooperation in a shearing action with a plurality of the shear members of the first rotary member and a plurality of second bars extend at right angles to the support member at spaced positions along the support member for cooperation in a shearing action with a plurality of the shear members of the second rotary member.

Preferably the first bars are longitudinally offset from the second bars so that they can cooperate with the shear members of the first and second rotary members which are also longitudinally offset.

Preferably the first and second bars are spaced each from the next by a distance greater than a thickness of the shear members so that they are positioned with spaces sufficient to allow the material to pass through.

Preferably the bars include a front edge facing the leading edges of the shear members which front edge is inclined downwardly and outwardly from the support member toward the wall of the first rotary member to better shear with the front edge of the shear member as it passes.

Preferably each of the bars has an endmost edge spaced from the support member so as to lie immediately adjacent the wall of the rotary member.

Preferably the bars are located at a height which is substantially aligned with a tangent across the top of the walls of the rotary members.

Preferably the support member comprises a longitudinal support beam positioned in the throat parallel to the axes at a height such that the radially outermost edges of the shear members pass the beam and so that a bottom edge of the bars is at a height above the plane of closest approach so as to leave a space underneath the bars in the throat before the plane.

Preferably each shear member on each of the rotary members is spaced longitudinally to leave a space between each shear member and the next on the rotary member at least equal to the thickness of one of the bars.

Preferably there is also provided a bottom grate member underneath the plane of closest approach including a support member extending parallel to the axes between the first and second rotary members, a plurality of bars extending at right angles to the support member at spaced positions along the first support member for cooperation in a shearing action with a plurality of the shear members of the first rotary member and a plurality of second bars extending at right angles to the support member at spaced positions along the support member for cooperation in a shearing action with a plurality of the shear members of the second rotary member.

Preferably the first and second bars are spaced by a distance substantially equal to a width of the shear members so that each shear member cooperates with two of the bars which are immediately on opposite sides of the shear member.

Preferably the first and second bars have a thickness substantially equal to a thickness of the shear members so that the first and second bars lie side by side with sides surfaces in contact.

Preferably the first and second bars have an upper edge extending upwardly and outwardly from the support member toward the respective rotary member.

Preferably the upper edges of the first and second bars are arranged in side elevation to extend downwardly and inwardly in a V-shape to intersect at a central apex.

Preferably the upper edges of the first and second bars are arranged to lie approximately in a radial plane of the axis of the respective rotary member so as to generate a shearing action with the shear members of the respective rotary member as they pass the upper edges.

Preferably the housing locates a plurality of apertures below the rotary members and outwardly of the support member of the bottom grate that are sized in a manner so as to selectively allow passage of the biomass material through the apertures.

Preferably the apertures are located at spaced positions along lengths of the drums for cooperation with a plurality of the shear members of the respective rotary member in a shearing action as the shear members pass over the apertures.

Preferably there is provided a plurality of elongate protrusions along an inner surface of the housing that respectively project towards one of the rotary members. The protrusions are oriented parallel to the axes of the rotary members and disposed at spaced positions intermediate groupings of the apertures.

Preferably the rotary members rotate at less than 10 rpm.

Preferably the rotary members rotate at rate so as to require less than 10 HP to drive rotation.

According to a second aspect of the invention there is provided a shredder for biomass material comprising:

first and second generally cylindrical rotary members mounted for rotation about parallel axes in opposed directions;

the members being supported so as to define at a plane of closest approach containing the axes of the rotary members a space therebetween and forming a throat on a feed side of the plane;

a housing within which the rotary members are mounted and defining a feed opening for receiving the biomass material arranged such that the biomass material fed into the feed opening enters the throat to pass through the space;

each of the rotary members having a cylindrical wall defining a hollow interior with a plurality of shear members projecting generally radially outwardly of the cylindrical wall;

each shear member having a leading surface, a trailing surface and first and second side surfaces;

the shear members being arranged in an array where the shear members of the array are spaced longitudinally and radially of the cylindrical wall;

wherein there is provided a top grate member in the throat including a support member extending along the throat generally parallel to the axes, a plurality of first bars extending at right angles to the support member at spaced positions along the support member for cooperation in a shearing action with a plurality of the shear members of the first rotary member and a plurality of second bars extending at right angles to the support member at spaced positions along the support member for cooperation in a shearing action with a plurality of the shear members of the second rotary member.

According to a third aspect of the invention there is provided a shredder for biomass material comprising:

first and second generally cylindrical rotary members mounted for rotation about parallel axes in opposed directions;

the members being supported so as to define at a plane of closest approach containing the axes of the rotary members a space therebetween and forming a throat on a feed side of the plane;

a housing within which the rotary members are mounted and defining a feed opening for receiving the biomass material arranged such that the biomass material fed into the feed opening enters the throat to pass through the space;

each of the rotary members having a cylindrical wall defining a hollow interior with a plurality of shear members projecting generally radially outwardly of the cylindrical wall;

each shear member having a leading surface, a trailing surface and first and second side surfaces;

the shear members being arranged in an array where the shear members of the array are spaced longitudinally and radially of the cylindrical wall;

wherein there is provided a bottom grate member underneath the plane of closest approach including a support member extending parallel to the axes between the first and second rotary members, a plurality of bars extending at right angles to the support member at spaced positions along the first support member for cooperation in a shearing action with a plurality of the shear members of the first rotary member and a plurality of second bars extending at right angles to the support member at spaced positions along the support member for cooperation in a shearing action with a plurality of the shear members of the second rotary member.

According to a further aspect of the invention there is provided a shredder for biomass material comprising:

at least one generally cylindrical rotary members mounted for rotation about a longitudinal axis;

a housing within which said at least one rotary member is mounted and defining a feed opening for receiving the biomass material;

a plurality of parallel bars carried on the housing at longitudinally spaced positions along said axis;

said at least one rotary member having a cylindrical wall defining a hollow interior with a plurality of shear members projecting generally radially outwardly of the cylindrical wall;

each shear member having a leading surface, a trailing surface and first and second side surfaces;

the shear members being arranged in an array where the shear members of the array are spaced longitudinally and radially of the cylindrical wall;

the shear members being arranged in the array thereof such that at least some of the shear members of the first rotary member pass respective ones of said bars in a shearing action between one of the side surfaces of said at least one of the shear members and a surface of said respective bar.

Preferably there is a single rotary member in the housing and the bars are arranged on the housing at one side of the rotary member such that rotation of the rotary member acts to carry the biomass material against the bars in the shearing action.

Preferably each of the shear members has a leading surface which is concave in a direction longitudinally of the leading surface so as to tend to grasp and pull the biomass material.

The shredder comprising the at least one rotary member, such as that having the single rotary member or the first and second rotary members, may be used in combination with a composting machine, which is directly fed by the shredder, for composting the biomass material.

According to yet another aspect of the invention there is provided a composting system for biomass material comprising:

a shredding machine for reducing the biomass material from a first size received at an inlet of the shredder to a second size discharged from an outlet of the shredder that is smaller than the first size;

a composting machine located at a distance from the shredder that includes:
a rotary vessel arranged for rotation about a horizontal longitudinal axis that has a cylindrical vessel wall and first and second end walls respectively carrying first and second openings, the first and second openings respectively defining an inlet for receiving the biomass material in the rotary vessel and an outlet for discharging the biomass material from the rotary vessel;
a tubular support member extending outwardly from the first end wall, outside of the rotary vessel, and along the horizontal longitudinal axis so as to be coaxial with the cylindrical vessel wall, the tubular support member being rotatably carried for supporting the rotary vessel in its rotation about the horizontal longitudinal axis at a first location which is closer to the first end wall than to the second wall;
a second support member spaced from the tubular support member along the horizontal longitudinal axis and toward the second end wall so as to define a second location closer to the second end wall than to the first end wall at which the rotary vessel is supported in its rotation about the horizontal longitudinal axis;
a plurality of agitating members extending inwardly from an inner face of the vessel wall which are oriented in a manner so as to encourage movement of the biomass material which is received in the rotary vessel towards the outlet thereof;

a driving arrangement arranged for driving rotation of the rotary vessel about its horizontal longitudinal axis;

a distance conveyor operatively coupling the shredding machine and the composting machine that is arranged to transfer the biomass material from the outlet of the shredding machine across said distance to the composting machine, the distance conveyor including (i) a tubular conveyor housing, (ii) a conveying member received in the housing for advancing the material within the tubular conveyor housing, and (iii) a drive assembly for driving the conveying member;

the composting machine further including an injector assembly at the inlet of the rotary vessel that is arranged for inputting the biomass material transferred by the distance conveyor from the shredding machine into the rotary vessel through the inlet thereof with the tubular support member being rotatable about the injector assembly, the injector assembly including:
an injecting conveyor comprising (i) a tubular injector housing, (ii) an injector conveying member spanning at least a full length of the tubular injector housing, and (iii) a drive assembly for driving the injector conveying member;
the injector conveyor being disposed along the horizontal longitudinal axis of the rotary drum and received in the tubular support member with an inner end located at or adjacent the first end wall and a gap formed circumferentially around an intermediate portion of the injector housing and radially between the injector housing and the tubular support member, the injector conveying member being arranged for advancing the biomass material toward and through the inlet of the rotary drum in an input direction along the horizontal longitudinal axis of the rotary drum.

The injector assembly allows biomass material to be introduced into the rotary vessel of the composting machine as the rotary vessel is rotated about its horizontal longitudinal axis, thereby providing an automated composting system which can be continuously fed with source material such as biomass material without interrupting rotation of the rotary composting vessel.

In one arrangement, the tubular support member extends inwardly from the first end wall in a direction towards the second end wall and there is provided one or more bracing members spanning between the tubular support member and the rotary vessel for rigidifying connection therebetween.

In one arrangement, the one or more bracing members comprises a plurality of gusset plates each of which has a first edge connected at an outer face of the tubular support member and a second edge connected at the first end wall.

In one arrangement, the driving arrangement includes a drive sprocket having a central opening so as to be received over the tubular support member at a location thereon externally of the rotary vessel such that the injector conveyor passes through the central opening of the drive sprocket.

At least one of the distance conveyor and the injector conveyor may further comprise a plurality of elongate cutter bars extending along a length of the housing of the respective one of the tubular housings at circumferentially spaced positions about an inner face thereof for further reducing size of the biomass material as it passes through the respective one of the conveyors.

### BRIEF DESCRIPTION OF THE DRAWINGS

Preferred embodiments of the invention will now be described in conjunction with the accompanying drawings in which:

FIG. 1 is a vertical cross-sectional view of a first embodiment of shredder according to the present invention using two parallel rotary drums where a number of shear members and protrusions are omitted in each of the rotary drums for convenience of illustration and showing only those of the shear members which are in shearing action at the point of closest approach of the rotary drums.

FIG. 1A is the same vertical cross-sectional view of the shredder as that of FIG. 1 and showing only those of the shear members which are in shearing action with the upper grate member.

FIG. 1B is the same vertical cross-sectional view of the shredder as that of FIG. 1 and showing only those of the shear members which are in shearing action with the bottom grate member.

FIG. 2 is a cross-sectional view along the lines 2-2 of FIG. 1.

FIG. 3 is a cross-sectional view along the lines 3-3 of FIG. 1.

FIG. 4 is a cross-sectional view along the lines 4-4 of FIG. 1.

FIG. 5 is a first isometric view of the shredder of FIG. 1 that also schematically illustrates the protrusions in FIG. 1 with a crisscross pattern to distinguish the rails.

FIG. 6 is a second isometric view of the shredder of FIG. 1 that also schematically illustrates the protrusions in FIG. 1 with a crisscross pattern to distinguish the rails.

FIG. 7 is a vertical cross-sectional view of a second embodiment of shredder according to the present invention using a single rotary drum which cooperates with shear bars carried on one side wall of the housing.

FIG. 8 is an isometric view of the embodiment of FIG. 7.

FIG. 9 is a side elevation view of a system of processing biomass material according to the present invention.

FIG. 10 is a side elevation view of a rear end of the biomass material processing system of FIG. 9 where a portion of a wall of each of a rotary vessel and extension tube is omitted in order to illustrate internal components thereof.

FIG. 11 is a side elevation view of a front end of the composter of FIG. 9 where some features are omitted for clarity of illustration.

FIG. 12 is an exploded view of a segmented oak bearing employed in the composter of FIG. 9.

FIG. 13 is a perspective view of the segmented oak bearing of FIG. 12.

FIG. 14 is an end view of the composter of FIG. 9 looking towards the front end thereof, with an end wall at a rear end of the composter and some other features omitted in order to illustrate internal components of the composter.

FIG. 15 is a perspective view of a front portion of the composter of FIG. 9 with a distance conveyor omitted for clarity of illustration.

FIG. 16 is a side elevation view like of the composting system like that in FIG. 9 but showing a front portion of the composting system where the shredder and composter are operatively coupled by a distance conveyor.

In the drawings like characters of reference indicate corresponding parts in the different figures.

### DETAILED DESCRIPTION

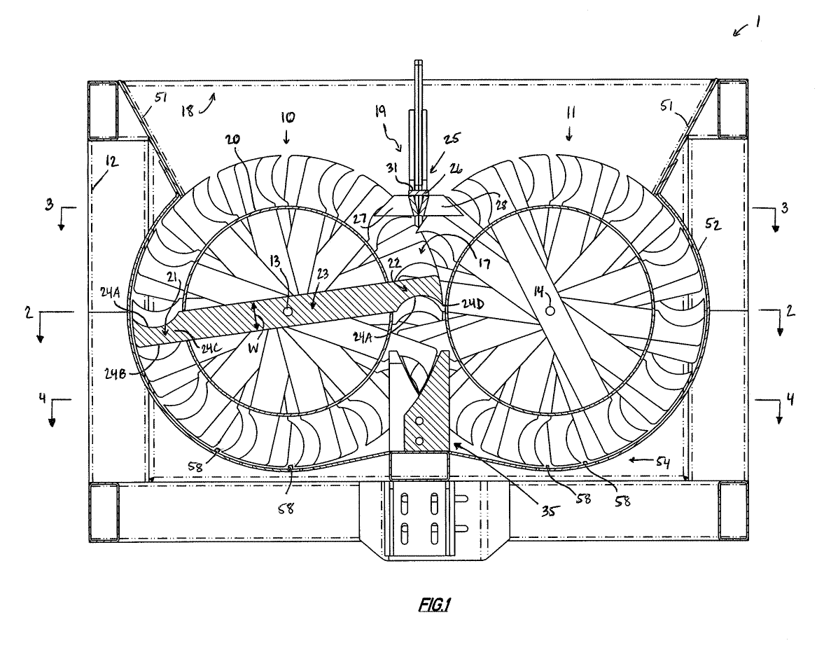

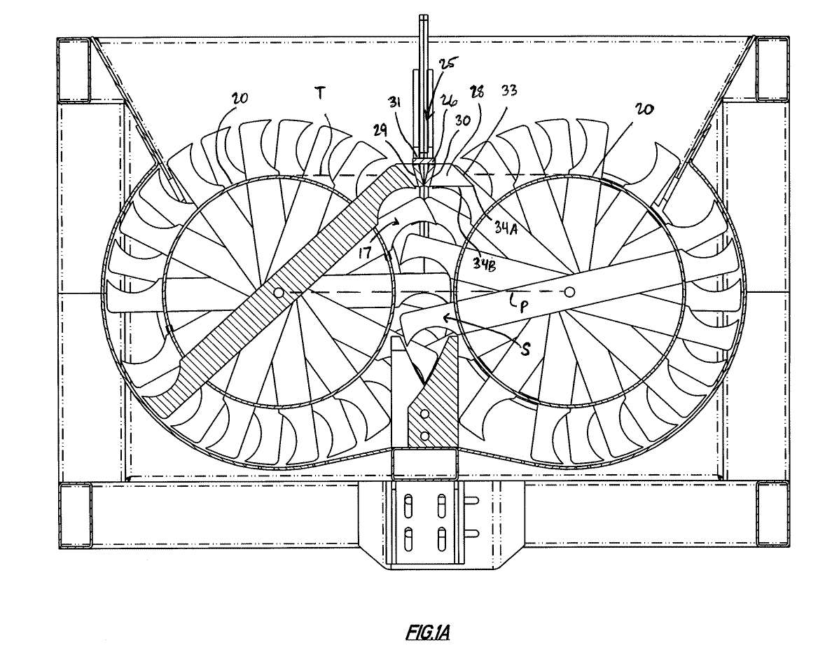

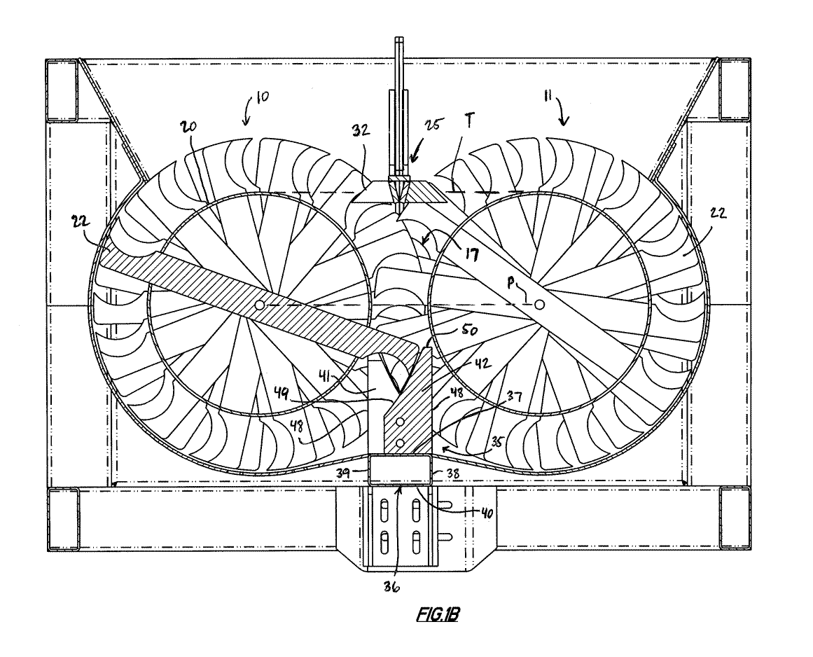

The shredder 1 of FIGS. 1 to 6 comprises first and second generally cylindrical rotary members or drums 10 and 11 mounted for rotation in a housing 12 where the drums are mounted on center drive shafts 13 and 14 driven for rotation by a conventional drive system 15 about parallel axes in opposed directions.

The drums are supported by the shafts on bearing 16 on the housing so as to define at a plane P of closest approach containing the axes of the rotary members a space S therebetween and forming a throat on a feed side of the plane P.

The housing 12 within which the rotary members are mounted has an open top 18 defining a feed opening 19 for receiving the biomass material where the biomass material is fed either manually or by a suitable conveyor into the feed opening and enters the throat 17 to pass through the space S. Suitable covers and guards (not shown) may be provided at the open top to prevent a fall into the feed throat causing personal danger.

Each of the rotary members 10, 11 has an imperforate cylindrical wall 20 defining a hollow interior with a plurality of shear members 21, 22 projecting generally radially outwardly of the cylindrical wall. The wall thus forms a simple drum of steel with open ends at the housing. The shear members 21, 22 are arranged in a pair including an elongate structural interconnecting member 23 extending diametrically through the hollow interior of the drum. Where the drum is driven by a drive shaft, the members 23 may be connected to the drive shaft 13 to communicate drive force. However other drive arrangements may be provided.

The shear members 21 and 22 and the interconnecting member are formed from a plate on each end of which a respective one of the pair is formed. Thus the plate has a constant thickness through the drum. As shown the plate has a width W which is also constant along its length up to the wall 20 which it meets at diametrically opposed positions where the wall is welded to the sides of the plate at the point of emergence though the wall. That portion of the plate which is exposed outside the drum forms the shear members 21 and 22 with a leading edge of the plate arranged to form the leading edge of the shear member. Thus in one example (not shown) each rotary member includes its own drive shaft through which rotational forces on the rotary member are applied and the elongate structural members 23 are connected to the drive shaft to receive rotational forces therefrom.

In FIG. 1 only one of the pairs is shown where each shear member has a leading surface 24A, a trailing surface 24B and first and second side surfaces 24C. The pairs formed by the plates are arranged so that the shear members are arranged in an array where the shear members of the array are spaced longitudinally and radially of the cylindrical wall.

As shown in FIG. 1, the drums are arranged so that, in the plane P, the shear members of one drum are angularly offset from the shear members of the other drum so that they are angularly spaced and out of phase as they pass.

Each of the shear members 20, 21 has its leading surface 24A which is concave in a direction longitudinally of the leading surface so as to form a hook with an outermost point 24D tending to grasp and pull the biomass material though the throat 17 and the plane P.

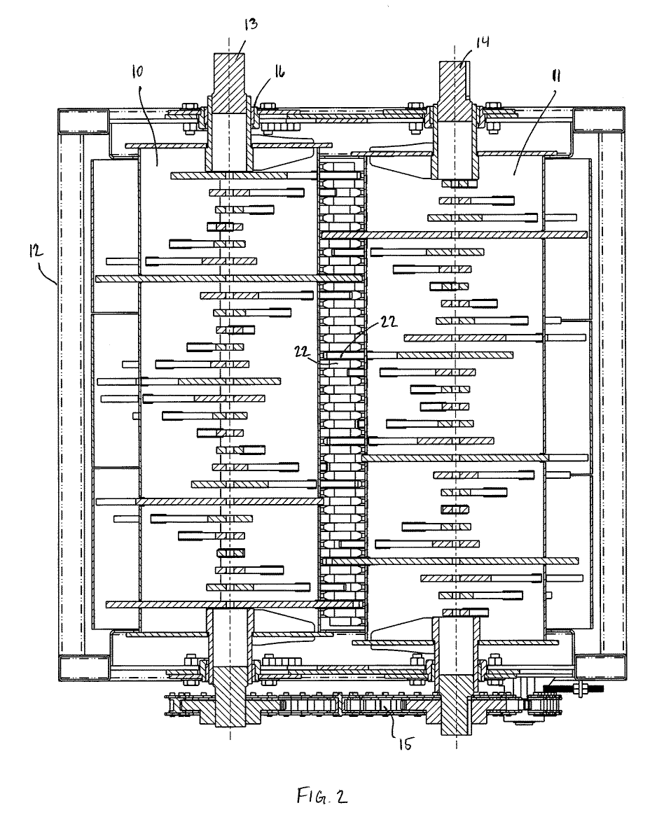

As best shown in FIGS. 1A and 3, there is provided a top grate member 25 in the throat 17. The top grate member includes a support beam 26 extending along the throat generally parallel to the axes of the two drums 11 and 12. The beam 26 is carried on the end walls 12A of the housing 12 so as to span along the length of the drums within the throat 17. The beam 26 has a top surface 31 facing the material as it is fed into the throat so as to provide a surface on which the material can sit. The beam has two side surfaces 29 and 30 which converge inwardly and downwardly to a center apex along the bottom of the beam. In this way the beam is generally triangular in cross-section with the two side walls approaching as close as possible to the outer edges of the shear members as they pass the beam. Thus the side walls lie generally in a plane peripheral to the axis of the adjacent drum.

The beam carries on one face 29 a plurality of first bars 27 extending at right angles to the beam at spaced positions along the beam 26 for cooperation in a shearing action with a plurality of the shear members 221 of the first rotary drum 10. The beam 26 also carries a plurality of second bars 28 extending at right angles to the beam 26 at spaced positions along the beam for cooperation in a shearing action with a plurality of the shear members 222 of the second rotary member 11. As best visible in FIG. 3, the first bars 27 are longitudinally offset from the second bars 28. In this way the bar 27 cooperates with one side face of the shear member 221 and the bar 28 cooperates with the other face of the shear member 222.

Also it can be seen in FIG. 3 that the first bars 27 are spaced each from the next by a distance greater than a thickness of the shear members 221. In this way there are spaces between the bars 27 at which no shear member is located allowing enough space for the material to be fed past the top grate into the throat. That is it is not intended that the maximum shearing action occur in the area of the top grate but instead the grate acts to hold up the material to be fed until it can be grasped by the hooked front surface of the shear members to be pulled into the throat. This improves the feeding action, acts as a pre-shredder for size reduction, and prevents the material from merely dancing over the shear members in the throat without a positive feeding action. The bars 28 are also symmetrically spaced relative to the bars 27.

As best shown in FIG. 1A, the bars 27 and 28 each have a leading edge 32, 33 facing the leading edges 24A of the shear members 221, 222 where the edges 32 and 33 are inclined downwardly and outwardly from the beam 26 toward the wall of the adjacent rotary member 10 or 11. (Note that the edge 32 is not visible in FIG. 1A but shown on FIG. 1B.) In particular each of the bars 27, 28 has an endmost edge or tip 34A spaced from the beam 26 so as to lie immediately adjacent or as close as possible to the wall 20 of the rotary member 10 or 11. That is the leading edge has a length approximately matching that of the shear member of the other drum. Also the angle of the leading edge is approximately on a radius of the associated drum.

The bars 27 and 28 have a top edge across the top of the beam 26 so that they form a common top surface of the grate. In the illustrated embodiment, the top surface of the grate 25 is located at a height above a tangent T across the top of the walls 20 of the rotary members 10 and 11 but below the open top 18 such that the biomass material fed into the open top may pass over and across the top grate until the material is grasped by the shear members of one drum or the other. Although the biomass material is able to pass over top of the grate 25, the bars are located at a height which is aligned with the tangent T and the grate sits sufficiently deep within the feed opening at a location in the throat to support the biomass material generally above the throat and resist jamming of the shear members in the space S between the drums that may be caused by, for example, passing an excessive amount of overly large pieces of the biomass material through the space S at one time. In other embodiments, the top surface of the grate 25 may be located at a height below the tangent T so that the top grate sits entirely in the throat. The bars 27 and 28 also have a bottom edge 34B of the bars which is at a common height with the bottom apex of the beam 26 and is at a height above the plane P of closest approach so as to leave a space underneath the bars in the throat 17 before the plane P.

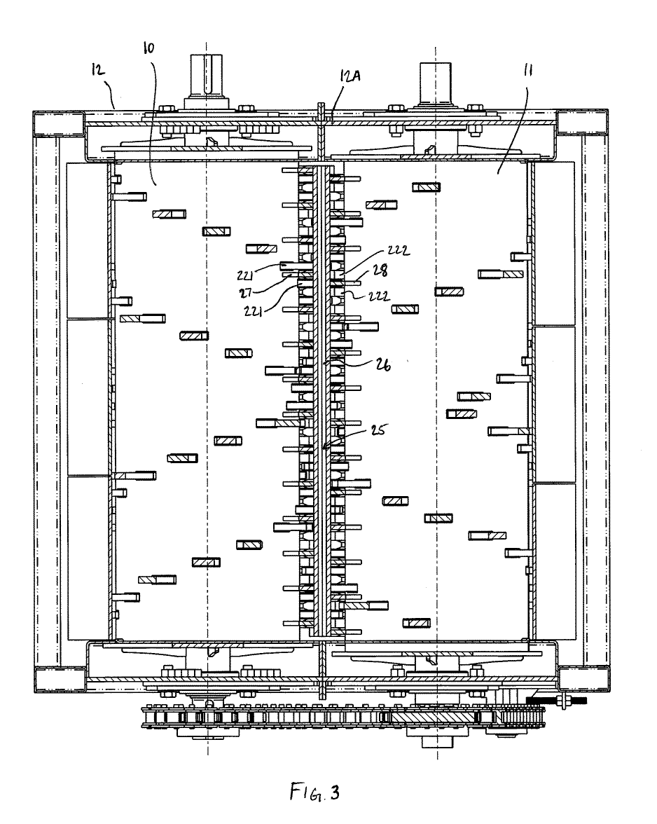

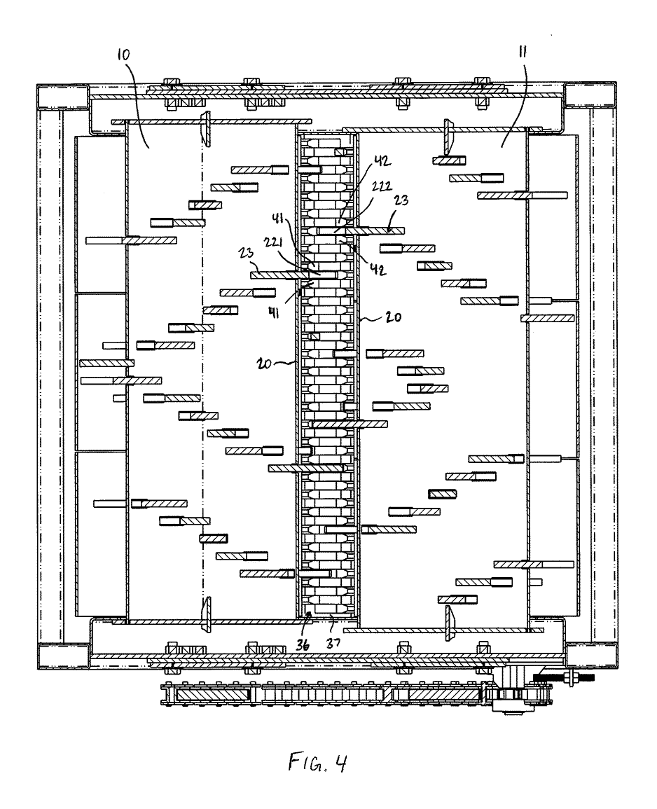

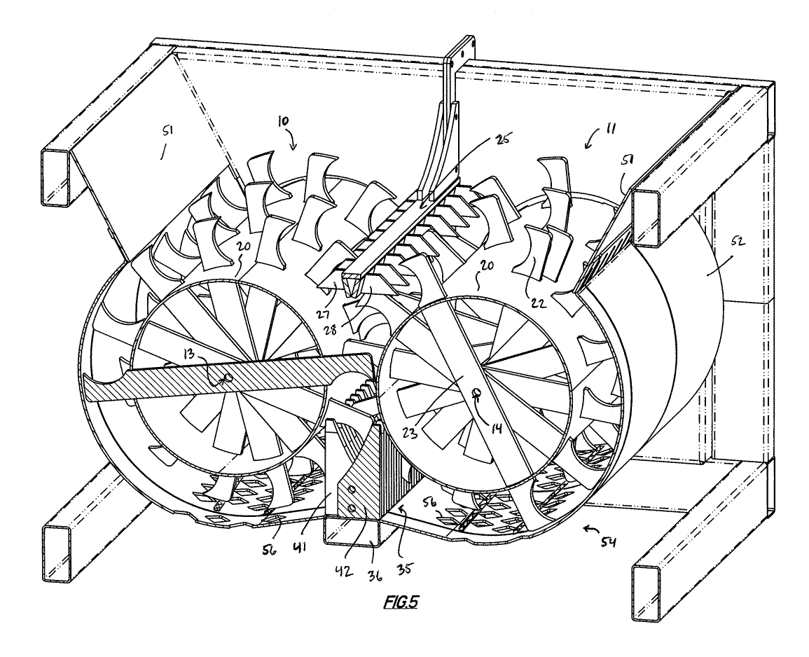

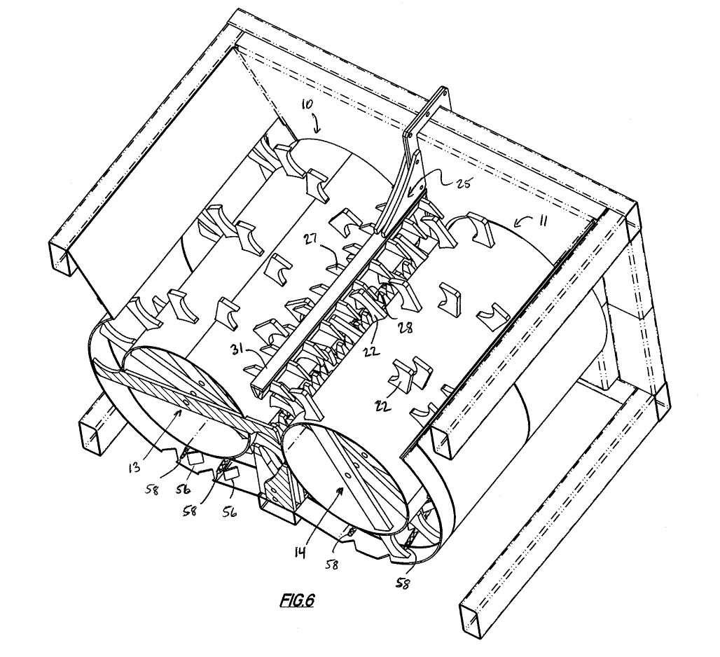

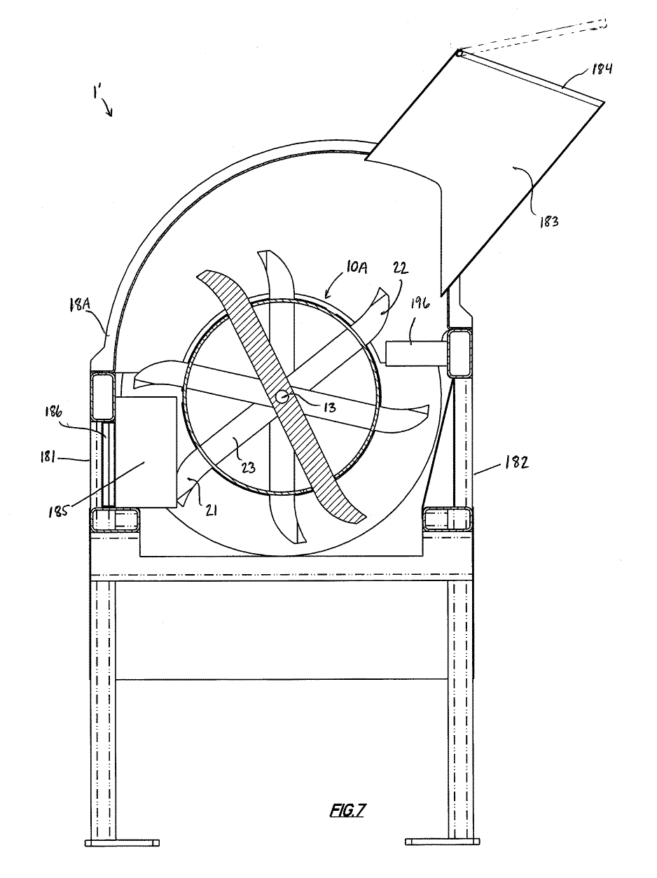

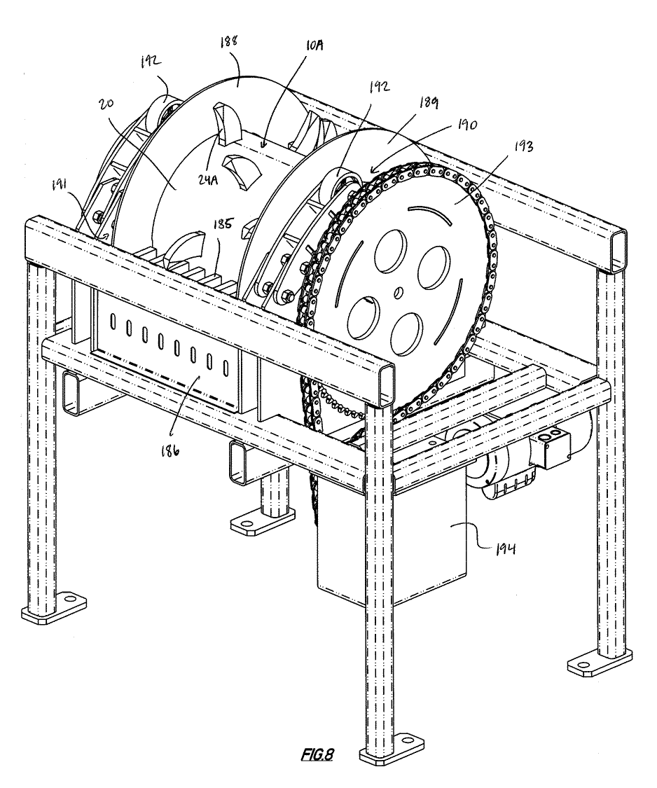

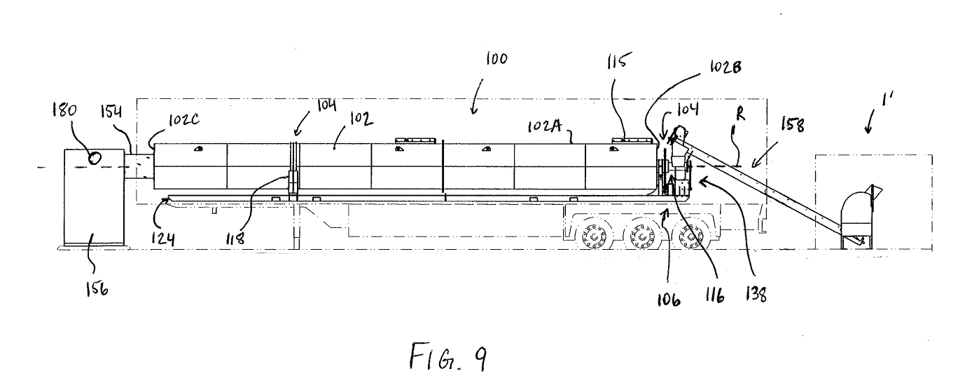

Referring now to FIGS. 1B and 4 there is provided a bottom grate 35 underneath the plane P of closest approach including a square support beam 36 extending parallel to the axes between the first and second rotary members 10, 11.

The beam 36 has a top wall 37, a bottom wall 40 and two side walls 38, 39 so as to be symmetrically located underneath the plane P. The beam is again located so that an outermost point of the shear members 22 can pass by the beam close to the beam.

As visible in FIG. 4, the beam carries a series of bars 41 cooperating with the drum 10 and a series of bars 42 cooperating with the drum 11. The bars are formed of the same plate material as the shear members so that the bars 41 are arranged in a row along the beam and interleave with the bars 42 of the drum 11 leaving a space between each bar 41 and the next substantially equal to the width of the shear members of the drum 10. Symmetrically the bars 42 are spaced by the bars 41 so as to define spaces therebetween to receive the shear members of the drum 11. The bars thus define a plurality of bars 41 extending at right angles to the support beam at spaced positions along the first support beam 36 for cooperation in a shearing action with a plurality of the shear members of the first rotary member 10 and a plurality of second bars 42 extending at right angles to the support beam at spaced positions along the support beam for cooperation in a shearing action with a plurality of the shear members of the second rotary member 11.

Thus the first and second bars 41, 42 have a thickness substantially equal to a thickness of the shear members 22 so that the first and second bars 41, 42 lie side by side with sides surfaces in contact. A suitable small clearance is provided to allow the shear members to pass though without binding or interference.

In this first embodiment as illustrated, the bars 41 and 42 have an outer edge 48 which is flush with the side walls 38, 39 of the beam 36. In other embodiments, the bars 41 and 42 may have an arcuate outer edge 48 immediately following the wall 20 of the respective drum. The bars have an upper edge 49 extending upwardly and outwardly from the support beam 36 toward the respective rotary member 10, 11 and joining the outer edge 48 to form a flat top tip 50.

Thus the upper edges 49 of the first and second bars 41, 42 are arranged in side elevation to extend downwardly and inwardly in a converging V-shape to intersect at a central apex 51. Also the upper edges of the first and second bars 41, 42 are arranged to lie approximately in a radial plane of the axis of the respective rotary member so as to generate a shearing action with the shear members 22 of the respective rotary member 10, 11 as they pass the upper edges.

The housing 12 includes upper walls 51 each which start at the open top 18 and taper inwardly towards one another and a lower wall 52 which spans between the upper walls and circumferentially about both drums so as to provide a closed bottom 54 below the open top. The lower wall 52 is spaced radially of the walls 20 of the drums 10, 11 to permit passage of the shear members therebetween. Furthermore, the lower wall 52 is contiguous with the top wall 37 of the bottom grate's beam 36 and is raised at a location beneath the throat 17 and space S between the drums 10 and 11 relative to the portions of the lower wall beneath the drums so that the material that is pulled through the bottom grate 35 and which cannot be grasped by the leading edge of the respective shear member tends to migrate towards lowest points along the lower wall.

The lower wall 52 locates a plurality of grating apertures 56 along the portions of the lower wall beneath each drum 10, 11 and outwardly of the beam 36 of the bottom grate. The grating apertures are located at spaced positions along the lengths of the drums. The grating apertures are sized in a manner so as to selectively permit passage of pieces of biomass material which are appropriately sized for the end product of the shredder. For example, the grating apertures may be sized equal to or smaller than the distance between an adjacent pair of the first or second bars of the bottom grate. Thus, the biomass material passing over the grating apertures that is sized too large to pass therethrough may be circulated about the respective drum so as to pass through the top and bottom grates another time for further size reduction. Additionally to having a screening function, the grating apertures 56, which are rhombus-shaped as better shown in FIGS. 5 and 6, may provide further size reduction in addition to the grates by generating a shearing action with a plurality of the shear members of the respective drum as they pass over the apertures.

Elongate protrusions 58 are disposed along an inner surface of the lower wall 52 of the housing at positions spaced angularly of one another. Each protrusion projects inwardly toward one of the drums 10, 11. The protrusions are oriented parallel to the axes of the drums 10, 11 and separate groupings of the grating apertures 56 which are arranged in rows parallel to the axes of the rotary members so as to be at spaced positions intermediate such groupings of the grating apertures. The protrusions provide obstructions against the biomass material to resist same from circling back to the feed openings if the material is sufficiently sized to pass through the apertures; however, the protrusions do not impede the passage of the shear members. The protrusions may be rectangular, for example square, in cross-section. In the illustrated embodiment, the protrusions comprise elongate rails which are secured at the inner surface of the lower wall 52. In other embodiments, the protrusions may be formed in the lower wall 52.

The arrangement provided herein provides a very effective shearing action on biomass material so that the rotary members can rotate at less than 10 rpm while pulling the material into the throat, through the plane P and through the bottom grate 36. This provides separate shearing actions which act to break up the material effectively to form a suitable fuel material or for composting. The use of this slow rate of rotation combined with the separate shearing actions allows the drive system to have a power requirement of less than 10 HP to drive rotation. Also the slow rate of rotation improves safety as it is less likely to cause sparks from vigorous impact with nails, rocks or the like.

The arrangement also provides a three stage shredding machine for reducing the biomass material in size from a whole state to a shredded or fragmented state.

Turning now to the embodiment of FIGS. 7 and 8, there is provided a shredder 1′ for biomass material which comprises a housing 18A and a single one of the drums or rotary members previously described indicated at 10A. The drum 10A includes the shear members 22 carried on the interconnecting members 23 and extending through the wall 20 of the drum.

In this embodiment there is a housing 18A with a front vertical wall 181 parallel to a rear wall 182. A feed chute 183 extending upwardly and rearwardly from the rear wall 182 for loading biomass material. The feed chute includes a hinged panel 184 at a top of the chute allowing the user to lift the panel and insert materials to be shredded. The housing has a length matching that of the drum and a width arranged to receive only a single drum within which the single drum is mounted underneath the feed opening defined by the feed chute 183 for receiving the biomass material.

The front wall 181 carries at a height approximately at the axis of the drum a plurality of parallel bars 185 carried on a structural member 186 of the wall 181 of the housing at longitudinally spaced positions along the axis of the drum. The bars are spaced by the width of the shear members 21, 22 to allow them to pass between respective bars in a shearing action.

As previously described, the shear members are arranged in an array where the shear members 21, 22 of the array are spaced longitudinally and radially of the cylindrical wall 20. The shear members are arranged such that at least some of the shear members of the rotary member pass respective ones of the bars 185 in a shearing action between one of the side surfaces of the shear members and a surface of the respective bar. The bars 185 are supported on the wall 181 so as to provide sufficient strength to accept the shearing action.

The single drum 10A carries a pair of divider disks 188, 189 which separate a center shearing section of the drum from end bearing sections 190, 191 where the drum is supported on rollers 192 and is driven by a gear wheel 193 at one end of the drum receiving drive from a sprocket of a drive motor 194. The rollers 192 may be substituted for bearings in other embodiments.

Thus in this embodiment there is a single rotary member 10A in the housing 18A and the bars 185 are arranged on the housing at one side of the rotary member such that rotation of the rotary member 10A acts to carry the biomass material against the bars 185 in the shearing action bearing in mind that the leading surface 24A of the shearing member has a leading surface which is concave in a direction longitudinally of the leading surface so as to tend to grasp and pull the biomass material and acts as a hook to carry the material downwardly against the bars 185.

A second set of bars 196, in a similar arrangement to the first set of bars 185, is mounted on the rear wall 182 to prevent material from falling behind the rear of the drum.

The drive arrangement used for the single drum where a gear wheel 193 is provided on the drum wall beyond one end of the shearing action can also be used in the double drum arrangement shown above.

The shredder of either one of the illustrated embodiments is suited for use in conjunction with a composting system which includes a composting machine or composter 102 directly fed by the shredder for processing biomass material. The shredder breaks up the biomass material before that material is passed through the composter. Such an arrangement is illustrated in FIG. 9, which shows the single drum shredder 1′ of the second embodiment.

The composter 100 comprises a rotary vessel 102 which is arranged for rotation about a horizontal longitudinal axis R. There is also provided a rotary support arrangement 104 for supporting the rotary vessel in its rotation, and a drive assembly 106 arranged for turning the rotary vessel about its horizontal longitudinal axis.

More specifically, the rotary vessel 102 has a cylindrical vessel wall 102A, and first and second end walls 102B and 102C. Each one of the end walls 102B, 102C carries an opening 109 and 110 therein. The first opening 109 located in the first end wall 102B at a front of the composter defines an inlet for receiving the biomass material. At a rear of the composter, the second opening 110 located in the second end wall 102C defines an outlet for discharging the biomass material from the rotary vessel.

A plurality of agitating members 112 are provided at spaced positions on an inner face of the vessel wall 102A so as to extend inwardly therefrom normal to a surface of the inner face. The agitating members 112 are spaced in a staggered manner both circumferentially about the vessel wall and longitudinally along this wall so as to be spaced angularly and axially of one another. In the illustrated arrangement, the agitating members form a plurality of vanes 112, which are obliquely oriented such that the vanes encourage movement of the biomass material which is received in the rotary vessel towards the outlet 110 of the vessel.

The composter includes an access opening 114 in the vessel wall 102A that is covered by an openable door 115 which closes the access opening during rotary operation of the composter.

In order to be configured for rotation, the rotary support arrangement 104 of the composter includes a tubular support member 116 at one end of the vessel and a second support member 118 closer to an opposing end of the vessel than the end locating the tubular support member.

In particular, the tubular support member 116 is located at the front of the rotary vessel. The tubular support member forms a tube which is smaller in diameter than the rotary vessel 102 and which is coaxially positioned with respect to the rotary vessel so as to lie along its horizontal longitudinal axis R. A front portion 116A of the tubular support members extends forwardly and outwardly from the first end wall 102B so as to reside outside of the rotary vessel 102, and a rear portion 116B extends rearward and inwardly from the first end wall 102B so as to reside inside of the rotary vessel.

In the illustrated arrangement, the outside front portion 116A of the tubular support member is rotatably carried on a segmented oak bearing 120, which is held just below the tubular support member in engagement therewith by a raised frame member 122. The raised frame member is part of a larger, overall frame 124 over which most (if not all) of the components of the composter 100 are supported. The segmented oak bearing 120 comprises a plurality of stacked oak blocks 126 received in a generally U-shaped receptacle 128 attached to the raised frame member 122. The oak blocks when stacked in a working configuration form an arc shaped groove 130 which cups the tubular support member 116 so that the rotary vessel is supported in its rotation about the horizontal longitudinal axis R by the tubular support member, which is disposed at a first location which is closer to the first end wall 102B than to the second end wall 102C. Moreover, the tubular support member includes a pair of flanges 129 extending circumferentially about the outer face of the outside front portion 116A of the tubular support member. This pair of flanges 129 has a longitudinal spacing therebetween which locates the segmented oak bearing 120 and maintains alignment therewith so that the composter is resisted from longitudinal shifting during rotation.

The second support member 118 comprises a pair of rollers 130 which rollably engage an outer face of the vessel wall 102A as the rotary vessel rotates about its horizontal longitudinal axis R. The rollers 130 are spaced longitudinally of the tubular support member 116 along the horizontal longitudinal axis R in a rearward direction from the first end wall 102B to the second end wall 102C as better shown in FIG. 9. The second support member thus defines a second location which is closer to the second end wall 102C than to the first end wall at which the rotary vessel is supported in its rotation about its horizontal longitudinal axis. Housing the rollers is a generally U-shaped frame member (not shown) that is supported on the overall frame 124 and which extends about the vessel wall 102A.

With the rotary vessel thus supported for rotation as described above, the rotary vessel must be rotatably driven in order to mix the biomass material. The drive assembly 106 comprises drive motors 131 operatively coupled to a driving arrangement which transfers motion of the motors into rotational motion which effects turning of the rotary vessel 102. The driving arrangement includes a drive sprocket 132 located at or adjacent the front end of the rotary vessel. The drive sprocket has a central opening 134 and is thus received over the front portion 116A of the tubular support member. The drive sprocket 132, the tubular support member 116, and the rotary vessel 102 are all coaxial with respect to the horizontal longitudinal axis R so as to share a common axis of rotation. Furthermore, the drive sprocket 132 is attached to the tubular support member 116, which is in turn affixed to the rotary vessel, so that the drive motors drivably engaging a belt or chain that in turn engages teeth of the drive sprocket 132 are able to effect the rotation of the rotary vessel.

One or more bracing members 136 are provided at the inside of the rotary vessel so as to rigidly connect the tubular support member 116 and the rotary vessel 102. Each bracing member 136 spans between the inside portion 1168 of the tubular support member and the rotary vessel. In the illustrated arrangement, the one or more bracing members comprises a plurality of gusset plates 136, each of which has a first edge 136A connected at an outer face of the tubular support member 116, a second edge 1368 connected at the first end wall 102B, and a third edge 136C spanning generally between the outer face of the tubular support member and the first end wall. Additionally, the bracing members are spaced angularly of one another in a uniform fashion so as to support the connection between the tubular support member and the rotary vessel at spaced positions along the circumference of the tubular support member.

At the front end, the composter includes an injector assembly 138 that is arranged for inputting biomass material into the rotary vessel through its inlet 109. Overall, the injector assembly is stationary such that it does not rotate, and therefore a conveyor 140 of the injector assembly is arranged so as to be held by upstanding frame members of the overall frame 124 at a suspended position within the tubular support member 116, free of engagement with the rotatable tubular support member through which the injector assembly passes.

The injector assembly 138 comprises the injector conveyor 140, which includes a tubular housing 142 and a conveying member 144 received therein. The conveying member 144 is of a suitable form such as a screw conveyor, delivering the biomass material along the horizontal longitudinal axis R of the rotary vessel. Furthermore, the tubular housing 142 is typically fully enclosed around its circumference. However, the tubular housing may have one or more openings, as in the illustrated arrangement where the tubular housing has a top opening 146 for receiving biomass material dropped into the injector assembly for subsequent transfer into the rotary vessel 102.

The injector conveying member 144 and injector tubular housing 142 enclosing same are disposed along the horizontal longitudinal axis R with inner ends located at or adjacent the first end wall 102B. More particularly, the inner ends are located inwardly of an inner end of the tubular support member 116 so as to extend inwardly beyond the tubular support member in the illustrated arrangement.

Furthermore, a rotational clearance gap CG is formed circumferentially around an outside of the tubular housing 142 where the tubular housing lies in the tubular support member. That is, an outer face of an intermediate portion 146 of the injector housing 142 is spaced radially of the tubular support member received over same so as to circumferentially surround the housing, and this gap CG exists radially between the intermediate portion 146 of the injector housing and the tubular support member around a full circumference of the housing's intermediate portion.

Since the tubular support member 116 is open at its inner end inside the rotary vessel, a suitable sealing membrane 148 in the form of a gasket, like a diaphragm seal, is disposed circumferentially around the injector housing 142 between same and the tubular support member thereby sealing the clearance gap G therebetween. The sealing membrane 148 is made of a flexible and stretchable material like rubber. The sealing membrane provides a tight seal across the clearance gap CG by stretching the membrane over the full circumference of the injector housing 142 and clamping this membrane to the tubular support member 116. Thus, the sealing membrane rotates together with the rotary vessel while in engagement with the outer face of the tubular injector housing.

Turning to the injector conveyor in more detail, the injector's conveying member 144 is arranged, for example by being sized and positioned in an appropriate manner, such that a gap is formed circumferentially around the screw conveyor between same and the tubular housing 142 of the injector assembly. In this gap, there is provided a plurality of elongate cutter bars 150 lying parallel to the horizontal longitudinal axis R. The cutter bars extend along a length of the injector housing 142 at circumferentially spaced positions about an inner face thereof, so as to be spaced angularly of one another. These cutter bars 150 provide a shearing action along the length of the housing 142 to reduce size of the biomass material as the material passes through the injector conveyor, being advanced by the injector conveying member 144.

A drive assembly 152 is provided with the injector assembly for driving the injector assembly's conveying member 144. The drive assembly 152 comprises a drive motor 152A which is operatively coupled to the screw conveyor 144 by a drive belt in order to drive axial rotation of the injector assembly's screw conveyor. As such, in the illustrated arrangement, the drive assembly of the injector assembly is separate from the drive assembly for the rotary vessel 102. However, in other arrangements, a common drive assembly may power both the rotation of the rotary vessel and the injector assembly's conveying member.

At the rear end of the rotary vessel 102, an extension tube 154 is affixed to the second end wall 102C of the rotary vessel so as to extend rearward and outwardly from the outlet 110 of the rotary vessel to a holding tank 156 for storing the biomass material. The extension tube carries agitating members 112 on its inner face, in a similar fashion to those within the rotary vessel, so as to encourage movement of the biomass material toward the holding tank.

As an overall working composting system, a shredder such as that indicated at 1′ is arranged to directly feed the composter 100, which then passes the biomass material into the holding tank 156. The shredder and composter are operatively coupled by a distance conveyor 158 that is arranged to transfer the biomass material from the outlet of the shredder to the composting machine across the distance therebetween. As such, the distance conveyor 158 comprises its own tubular conveyor housing 160 and a suitable conveying member 162, such as a screw conveyor, which is received in the tubular conveyor housing 160 for advancing the material within the conveyor housing 160. A drive assembly 164 is also provided with the distance conveyor in order to drive the conveying member 162, such as in rotation about its axis in the illustrated arrangement of the screw conveyor. The distance conveyor has its own drive assembly as the distance conveyor is standalone of the shredder and the composting machine, through operation as part of the composting system, the distance conveyor cooperates with both the shredder and composter. For example, a rate at which the distance conveyor transfers the biomass material is typically proportional to (i) a rate at which biomass material is shredded in the shredder and (ii) a rate at which the injector conveyor 138 advances the biomass material into the rotary vessel 102.

In the illustrated arrangement, the distance conveyor 158 is supported at each end thereof in an inclined orientation with a lower end 158A beneath the outlet of the shredder 1′ and an upper end 158B over an inlet of the injector conveyor that is defined by the top opening 146 in the injector tubular housing. The distance conveyor is oriented at an incline because the shredder 1′ and composting machine 100 are carried at different elevations with the shredder being a stationary unit and the composting machine being a mobile unit carried in a portable trailer.

The distance conveyor 158 includes an inlet chute 166 extending upwardly from the tubular housing 160 at its lower end so as to guide biomass material from the outlet of the shredder into the conveyor housing. The tubular housing is circumferentially enclosed along its full axial length so as to contain the biomass material within the distance conveyor as it is transferred therealong, except where the inlet chute 166 is located at the lower end of the distance conveyor and an inlet chute 168 of the injector conveyor meets the tubular housing 160 of the distance conveyor to guide the biomass material thereto.

Additionally, the distance conveyor includes a deflector 170 within the tubular housing 162 at its outlet. The deflector forms a plate 170 which is obliquely oriented relative to the axis of the conveying member 162 so as to guide the biomass material downwardly into the injector assembly's inlet chute 168, over which the deflector is disposed.

As the biomass material is advanced axially along the distance conveyor, a plurality of elongate cutter bars 172 provided inside the tubular housing 162 of the distance conveyor provide shearing surfaces against which the conveyed biomass material may be further reduced in size after having passed through the shredder. These cutter bars 172 of the distance conveyor are arranged in a similar manner as those 150 of the injector assembly, being disposed parallel to the axis of rotation of the distance conveyor's conveying member 162 and being spaced circumferentially about an inside face of the circumferentially enclosed tubular housing of the distance conveyor.

At the outlet of the distance conveyor, the inlet chute 168 of the injector assembly which extends upwardly from the tubular housing 142 thereof guides the biomass material into the injector conveyor. The injector conveyor's conveying member 144 advances this material axially along and the enclosing tubular housing, and into the rotary vessel 102 of the composting machine.

The agitating members 112 of the rotary vessel and the extension tube encourage the movement of the biomass material through these elements and into the holding tank 156 as the rotary vessel and extension tube rotate about the horizontal longitudinal axis R. A scoop 174 disposed in the rotary vessel and affixed to the second end wall 102C at the outlet 110 of the rotary vessel helps the biomass material transition from the rotary vessel into the diametrically smaller sized extension tube 154.

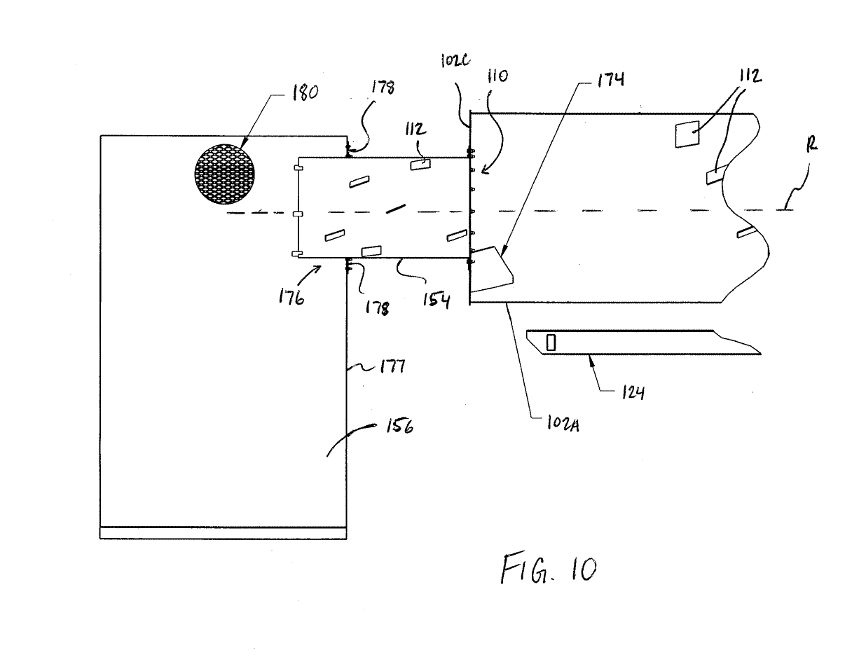

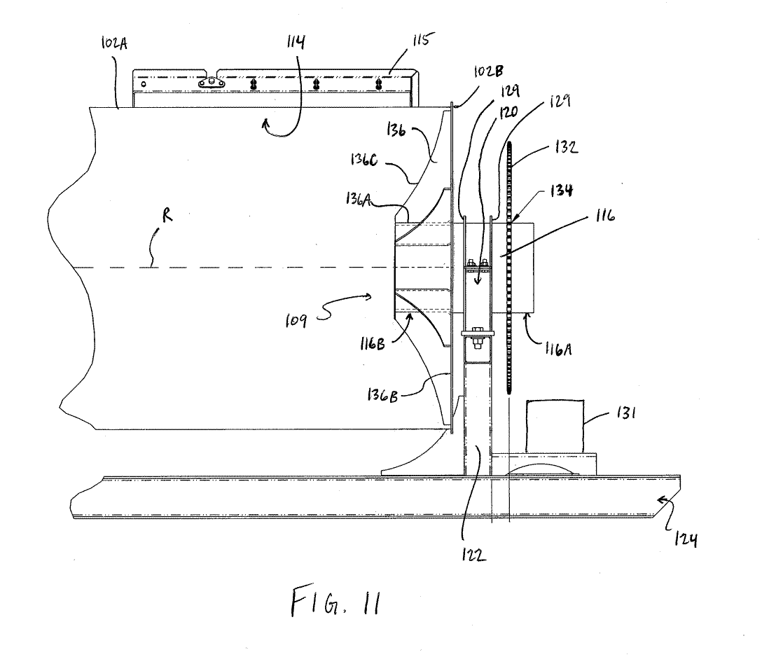

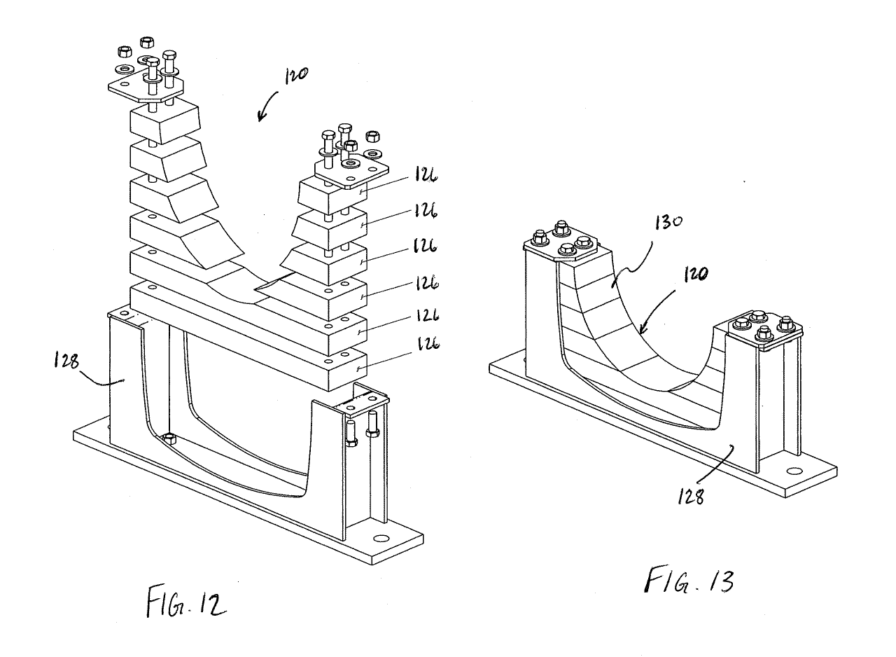

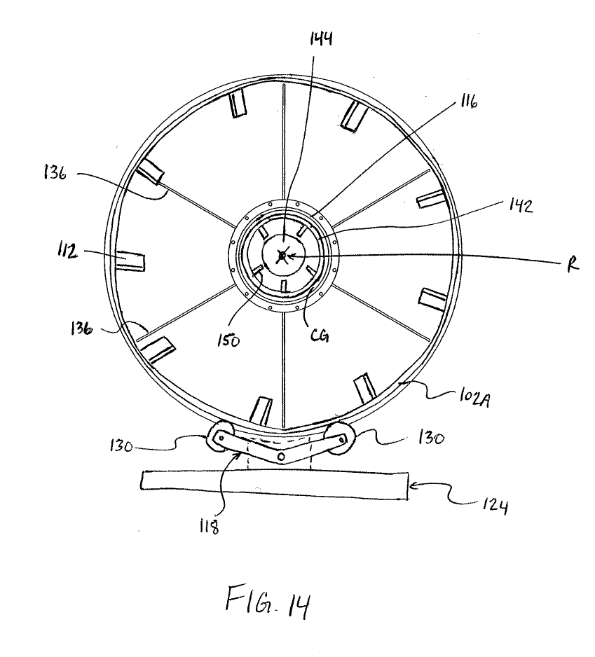

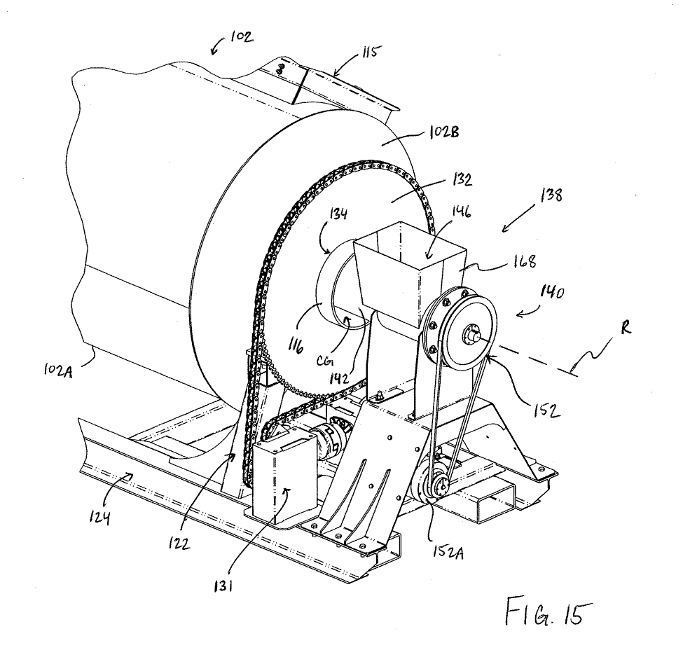

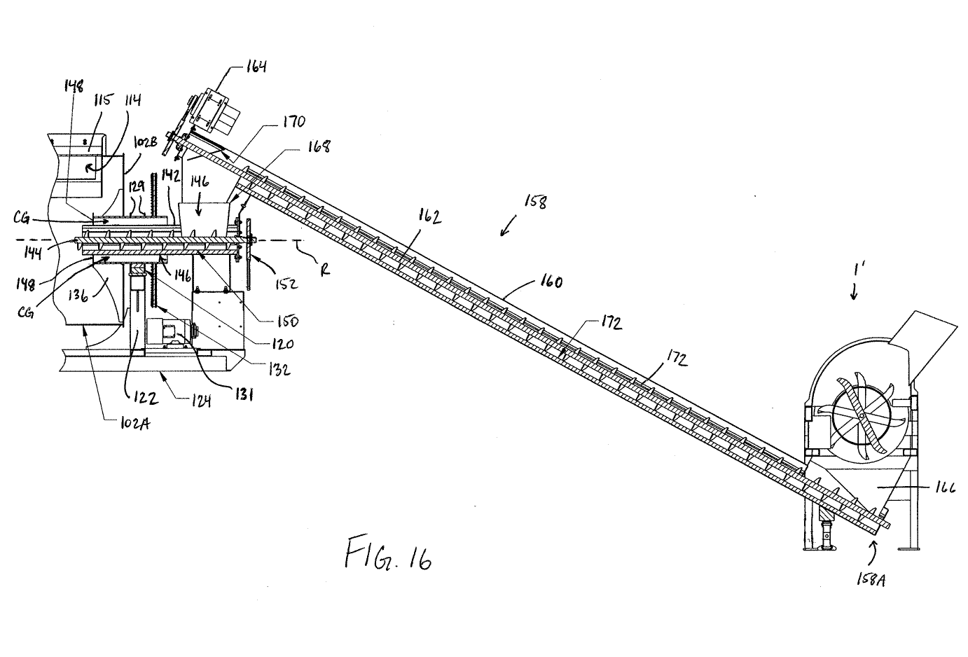

As better shown in FIG. 10, the holding tank 156 includes an opening 176 in a side wall 177 through which the extension tube 154 passes such that a length portion of the extension tube is locatable in the holding tank. A sealing gasket 178 (schematically illustrated) is provided at the opening 176 in the side wall so as to circumferentially seal the opening around the extension tube.

Also, an exhaust fan 180 (schematically illustrated) provided in the holding tank 156 induces airflow through the rotary vessel 102 and extension tube 154 as part of the composting process.

Note that the holding tank 156 is arranged so as to be detachable from the extension tube. As such, the holding tank is removable from the composting system such as for transferring the composted biomass material to another container or location.

Thus, the shredder is suited for accepting the biomass material in a whole state in which the material includes leaves, stems or stalks, and other parts of the plant. The shredder shreds or fragments the biomass material so as to reduce it in size from the whole state to a fragmented state in which the biomass material is in a particulate form relative to the whole state. That is, the fragmented state of the biomass material comprises pieces which are smaller in size than the biomass material in the whole state. Once in the fragmented state, a suitable conveyor 158 termed ‘distance conveyor’ transfers the biomass material in the fragmented state to the composter 100 for composting. Typically, composters require the biomass material to be sized less than a maximum allowable size in order to fit into the machine, and the shredder of either one of the illustrated embodiments is suited for breaking up biomass material to fit such size constraints of the composter.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A shredder for biomass material comprising:
at least one generally cylindrical rotary member mounted for rotation about a longitudinal axis;
a housing within which said at least one rotary member is mounted and defining a feed opening for receiving the biomass material;
said at least one rotary member having a cylindrical wall defining a hollow interior with a plurality of shear members projecting generally radially outwardly of the cylindrical wall;
each shear member having a leading surface, a trailing surface and first and second side surfaces;
the shear members being arranged in an array where the shear members of the array are spaced longitudinally and radially of the cylindrical wall;
the shear members being arranged in the array thereof such that at least some of the shear members of the first rotary member pass respective cooperating components in a shearing action between one of the side surfaces of said at least one of the shear members and a surface of said respective cooperating component;
wherein the shear members are arranged in pairs with each pair including an elongate structural member extending through the hollow interior of the rotary member on each end of which the respective one of the pair is mounted.

2. The shredder according to claim 1 wherein the elongate structural members extend diametrically through the rotary member.

3. The shredder according to claim 1 wherein each of the shear members has a leading surface which is concave in a direction longitudinally of the leading surface so as to tend to grasp and pull the biomass material.

4. The shredder according to claim 1 wherein the pair of shear members and the elongate structural member thereof are formed from an integral plate with the leading surface of each shear member being forming at one edge of the plate.

5. The shredder according to claim 1 wherein said at least one rotary member comprises first and second generally cylindrical rotary members mounted for rotation about parallel axes in opposed directions, the members being supported so as to define at a plane of closest approach containing the axes of the rotary members a space therebetween and forming a throat on a feed side of the plane, the housing defining said feed opening arranged such that the biomass material fed into the feed opening enters the throat to pass through the space.

6. The shredder according to claim 5 wherein there is provided a top grate member in the throat including a support member extending along the throat generally parallel to the axes, a plurality of first bars extending at right angles to the support member at spaced positions along the support member for cooperation in a shearing action with a plurality of the shear members of the first rotary member and a plurality of second bars extending at right angles to the support member at spaced positions along the support member for cooperation in a shearing action with a plurality of the shear members of the second rotary member.

7. The shredder according to claim 6 wherein the first bars are longitudinally offset from the second bars.

8. The shredder according to claim 6 wherein the first and second bars are spaced each from the next by a distance greater than a thickness of the shear members.

9. The shredder according to claim 6 wherein the bars of the first plurality include a front edge facing the leading edges of the shear members which is inclined downwardly and outwardly from the support member toward the wall of the first rotary member and the bars of the second plurality include a front edge facing the leading edges of the shear members which is inclined downwardly and outwardly from the support member toward the wall of the second rotary member.

10. The shredder according to claim 6 wherein each of the bars has an endmost edge spaced from the support member so as to lie immediately adjacent the wall of the rotary member.

11. The shredder according to claim 6 wherein the bars are located at a height which is substantially aligned with a tangent across the top of the walls of the rotary members.

12. The shredder according to claim 6 wherein the support member comprises a longitudinal support beam positioned in the throat parallel to the axes at a height such that the radially outermost edges of the shear members pass the beam.

13. The shredder according to claim 6 wherein a bottom edge of the bars is at a height above the plane of closest approach so as to leave a space underneath the bars in the throat before the plane.

14. The shredder according to claim 6 wherein each shear member on each of the rotary members is spaced longitudinally to leave a space between each shear member and the next on the rotary member at least equal to the thickness of one of the bars.

15. The shredder according to claim 6 wherein there is provided a bottom grate member underneath the plane of closest approach including a support member extending parallel to the axes between the first and second rotary members, a plurality of first bars extending at right angles to the support member at spaced positions along the first support member for cooperation in a shearing action with a plurality of the shear members of the first rotary member and a plurality of second bars extending at right angles to the support member at spaced positions along the support member for cooperation in a shearing action with a plurality of the shear members of the second rotary member.

16. (canceled)

17. (canceled)

18. (canceled)

19. (canceled)

20. (canceled)

21. The shredder according to claim 15 wherein the housing locates a plurality of apertures below the rotary members and outwardly of the support member of the bottom grate that are sized in a manner so as to selectively allow passage of the biomass material through the apertures.

22. The shredder according to claim 21 wherein the apertures are located at spaced positions along lengths of the drums for cooperation with a plurality of the shear members of the respective rotary member in a shearing action as the shear members pass over the apertures.

23. (canceled)

24. A shredder for biomass material comprising:
first and second generally cylindrical rotary members mounted for rotation about parallel axes in opposed directions;
the members being supported so as to define at a plane of closest approach containing the axes of the rotary members a space therebetween and forming a throat on a feed side of the plane;
a housing within which the rotary members are mounted and defining a feed opening for receiving the biomass material arranged such that the biomass material fed into the feed opening enters the throat to pass through the space;
each of the rotary members having a cylindrical wall defining a hollow interior with a plurality of shear members projecting generally radially outwardly of the cylindrical wall;
each shear member having a leading surface, a trailing surface and first and second side surfaces;
the shear members being arranged in an array where the shear members of the array are spaced longitudinally and radially of the cylindrical wall;
wherein there is provided a top grate member in the throat including a support member extending along the throat generally parallel to the axes, a plurality of first bars extending at right angles to the support member at spaced positions along the support member for cooperation in a shearing action with a plurality of the shear members of the first rotary member and a plurality of second bars extending at right angles to the support member at spaced positions along the support member for cooperation in a shearing action with a plurality of the shear members of the second rotary member.

25. (canceled)

26. A shredder for biomass material comprising:
at least one generally cylindrical rotary members mounted for rotation about a longitudinal axis;
a housing within which said at least one rotary member is mounted and defining a feed opening for receiving the biomass material;
a plurality of parallel bars carried on the housing at longitudinally spaced positions along said axis;
said at least one rotary member having a cylindrical wall defining a hollow interior with a plurality of shear members projecting generally radially outwardly of the cylindrical wall;
each shear member having a leading surface, a trailing surface and first and second side surfaces;
the shear members being arranged in an array where the shear members of the array are spaced longitudinally and radially of the cylindrical wall;
the shear members being arranged in the array thereof such that at least some of the shear members of the first rotary member pass respective ones of said bars in a shearing action between one of the side surfaces of said at least one of the shear members and a surface of said respective bar.

27. The shredder according to claim 26 wherein there is a single rotary member and the bars are arranged on the housing at one side of the rotary member such that rotation of the rotary member acts to carry the biomass material against the bars in the shearing action.

28. (canceled)

29. (canceled)

30. (canceled)

31. (canceled)

32. (canceled)

33. (canceled)

34. (canceled)
